(19) United States
(12) Patent Application Publication
(10) Pub. No.: US 2010/0327021 A1
(43) Pub. Date: Dec. 30, 2010

(54) DOSAGE AND TRANSFER VALVE, DOSING PUMP COMPRISING SUCH A PIVOTING VALVE, AND INSTALLATION FOR PRODUCING DAIRY OR CHEESE PRODUCTS, COMPRISING AT LEAST ONE SUCH PUMP

(75) Inventor: Alain Roumeau, Doeuil Sur Le Mignon (FR)

Correspondence Address: CANTOR COLBURN LLP, 20 Church Street, 22nd Floor, Hartford, CT, 06103, US

(73) Assignee: Equipements Techniques Des Industries Alimentaires Et Connexes Tecnal

(21) Appl. No.: 12/918,604

(22) PCT Filed: Feb. 11, 2009
(86) PCT No.: PCT/FR09/00153

§ 371 Date: Aug. 20, 2010

(30) Foreign Application Priority Data
Feb. 28, 2008 (FR) 08/01094

(51) Int. Cl. G01F 13/00

(52) U.S. Cl. 222/252; 222/251

(57) ABSTRACT

The invention relates to a dosing pump (1) especially for a product which is to be pumped and dosed and has a more or less pasty, especially heterogeneous and fragile, consistency, comprising, along an axis (6): a cylinder head (7) having a circular cylindrical transfer chamber (10), a suction opening (8) and a discharge opening (9) in the same axial position, radially staggered in relation to each other; a mobile suction and discharge piston (12) that can be axially slid in relation to the cylinder head (7), by driving means (13), between a proximal position and a distal position wherein its head (14) is respectively essentially at least in and at least out of the chamber (10); and a circular cylindrical revolving dosing and transfer valve (15) that can be rotatably displaced in relation to the cylinder head (7), between its functional angular positions, said valve comprising a recess (18) having an end opening (19) adjacent to its free end edge (17) and a peripheral opening (20) that can communicate with the suction opening (8) in the suction position, and with the discharge opening (9) in the discharge position. The peripheral opening (20) has a U-shaped, square

### TECHNICAL FIELD

The invention firstly concerns a dosage and transfer valve specially designed for a dosing pump comprising such a pivoting valve, secondly such a dosing pump, specially designed for a product to be pumped and dosed and having a more or less pasty, especially heterogeneous and fragile, consistency, and, thirdly, an installation for producing dairy or cheese products (or similar products) in a plurality of molds, comprising at least one such pump.

Known from the public domain are installations for producing dairy or cheese products comprising:
intake means for the product to be pumped and dosed, placed in an upper portion, including at least one lower outlet opening,
a plurality of molds designed to receive one—or a number of—dose(s) of the product to be produced, placed in the lower portion,
means for distributing the product, including at least one upper intake opening and at least one lower outlet opening, placed above the molds, capable of distributing via its outlet opening, one—or a given number of—dose(s) of the product in each of the molds of the plurality of molds,
at least one dosing pump, the axis of which is arranged essentially horizontally, the cylinder head of which is inserted between the intake means and the distribution means, whereof the suction opening communicates with the outlet opening of the intake means, and whereof the discharge opening communicates with the inlet opening of the distribution means.

According to one design known from the public domain, such a pump comprises:
a cylinder head having a revolving transfer chamber and, on its side wall, a suction opening and a discharge opening radially staggered relative to each other,
a mobile suction and discharge piston that can be axially slid in relation to the cylinder head by sliding driving means between a proximal position and a distal position where its head is respectively essentially at least in and essentially at least out of the transfer chamber,
a dosage and transfer valve, with a shape complementary to the transfer chamber, mounted coaxially in a portion of the transfer chamber forming a seat situated opposite and facing the piston, said valve being capable of being rotatably moved relative to the cylinder head by rotating driving means, the valve including a peripheral opening capable of being brought opposite—and in communication with—the suction opening or the discharge opening.

In the embodiment described in document FR-A-2 613 782, the piston is conical in shape, like the valve and its recess, while the peripheral opening of the valve is limited by circular edge.

In the embodiment described in document FR-A-2 832 467, the peripheral opening of the valve is limited by a first circularly rounded transverse edge and by two diverging longitudinal edges. Such a constructive arrangement aims, according to the document in question, to prevent, as much as possible, the presence of a hard body in the product to be pumped and dosed from causing damage to the pump.

In the embodiment described in document FR-A-2 832 466, the suction and discharge openings are in neighboring, but axially staggered, angular positions, the valve including two lumens staggered angularly and axially.

The invention aims to propose a valve, a pump and an installation based on the generally known design recalled above, but different in their embodiments from those described in documents FR-A-2 613 782, FR-A-2 832 466, and FR-A-2 832 467.

### BRIEF SUMMARY

Owing to these new embodiments of the valve, the pump incorporating it, and therefore the installation including one or several such pumps, the invention targets an embodiment that simultaneously is simple, allows suction and discharge of the product to be pumped and dosed that are both effective and efficient, and ensures high-performance washing of the pump. More specifically the invention targets an embodiment that is particularly well suited to a product to be pumped that is pasty, heterogeneous (curd and serum), and fragile. To this end, it is desirable for the intake and evacuation openings of the pump to be as large as possible. Lastly, it is important that the “dead” volume of product likely to remain in the cavity of the pump be minimal.

To that end, according to a first aspect, the invention proposes a dosage and transfer valve, especially designed for a dosing pump with pivoting valve, said valve—having first and second free end edges—fits into an outer revolving jacket and includes a recess, said recess having, on one hand, an end opening adjacent to the second free end edge and, on the other hand, a peripheral opening, characterized:
firstly, by a jacket having a general circular cylindrical shape, and
secondly, by a peripheral opening:
   that, in elevation, has a general U- or □-shaped contour,
   and that is limited:
      on one hand, by at least one first transverse edge situated toward the first free end edge while being remove from it,
      and, on the other hand, by two longitudinal edges arranged essentially parallel to each other and to the direction of the axis of the valve.

According to one embodiment, described in detail hereinafter, the valve includes a single peripheral opening. According to another possible embodiment, the valve includes two peripheral openings angularly staggered relative to each other.

In the case of a peripheral opening having a generally U-shaped contour, this peripheral opening, firstly, is limited, on one hand, by a first single transverse edge and, on the other hand, by two longitudinal edges, and, secondly, is separated from the first free end edge of the valve and adjacent to its second free end edge, the peripheral opening and the end opening together forming a notch formed in the valve.

In the case of a peripheral opening have a generally □-shaped contour, this peripheral opening, firstly, is limited, on one hand, by first and second transverse edges respectively separated from the first and second free end edges of the valve and, on the other hand, by two longitudinal edges and, secondly, is separated from the first and second free end edges of the valve.

According to the embodiments, a longitudinal edge is provided whereof a substantial portion, at least, is essentially rectilinear, a transverse edge is provided whereof a substantial portion, at least, is essentially a circular arc, rectilinear in elevation, a rounded portion is provided between a longitudinal edge and either a transverse edge or the second free end edge of the valve when the peripheral opening is adjacent thereto.

Depending on the embodiments, a peripheral opening is provided extending axially over a substantial portion of the axial length of the valve between its two free end edges; a peripheral opening is provided extending angularly, relative to the axis of the valve, over an angle α that can reach up to the vicinity of 120□.

According to one embodiment, a recess is provided fitting into a revolving jacket of circular, generally cylindrical or pseudo-cylindrical shape. According to one embodiment, a recess is provided having, in transverse straight section, relative to the axis of the valve, a general pseudo-V shape, the tip, forming the axial longitudinal bottom of the recess, being greatly rounded. In this case, the opening angle β of the pseudo V can reach up to the vicinity of 90□.

According to one embodiment, a recess is provided having a rounded axial longitudinal bottom diametrically opposite the peripheral opening and, on either side of the bottom, two diverging lateral faces, essentially planar, extending up to the longitudinal edges on the cylindrical outer face of the valve whereof the thickness decreases between the bottom of the recess and the longitudinal edges of the peripheral opening.

According to one embodiment, a recess is provided having a face axially opposite the end opening inclined in the direction going from the first to the second free end edge and from the side of the peripheral opening to the rounded axial longitudinal bottom of the recess.

According to a second aspect, the invention proposes a dosing pump with pivoting valve, specially designed for a product to be pumped and dosed with a more or less pasty, especially heterogeneous (such as curd and serum) and fragile, consistency comprising:
a cylinder head having a revolving transfer chamber and, on its side wall, a suction opening and a discharge opening radially staggered relative to each other,
a mobile suction and discharge piston that can be axially slid in relation to the cylinder head by sliding driving means between a proximal position and a distal position wherein its head is respectively essentially at least in and at least out of the transfer chamber,
a transfer chamber whereof the jacket has a generally circular cylindrical shape,
a dosage and transfer valve as just described, with a shape complementary to the transfer chamber, mounted coaxially in a portion of the transfer chamber forming a seat situated opposite and facing the piston, said valve being capable of being rotatably moved relative to the cylinder head by rotating driving means, such that its peripheral opening can be opposite—and in communication with—the suction opening or the discharge opening,
and a piston whereof the head has a generally cylindrical shape, at least substantially complementary to that of the recess of the valve.

According to one embodiment, a suction opening and discharge opening are provided having, in elevation, a generally square or rectangular shape (hereinafter □) limited by two transverse edges and two essentially parallel and axial longitudinal edges.

According to one embodiment, a suction opening and a discharge opening are provided having, in elevation, a general □ shape, that is at least equal and possibly larger and enveloping the peripheral opening of the valve.

According to one embodiment, a piston head is provided with a generally cylindrical shape and a distal face with a generally hemispheric shape.

According to one embodiment, a suction opening and a discharge opening are provided essentially diametrically opposite relative to the axis of the chamber and the valve.

According to one embodiment, it is provided that the valve can occupy one of the following four functional angular positions:
an opening position, in particular for washing, in which the peripheral opening of the valve is separated from the face of the cylinder head situated facing it, a passage being possible between the suction opening and the discharge opening of the cylinder head, via the recess of the valve,
a suction position, wherein the peripheral opening of the valve communicates with the suction opening of the cylinder head placed above, while the wall of the valve closes the access to the discharge opening of the cylinder head and the recess of the valve can receive a dose of product to be pumped and dosed,
a transitional covering position, wherein the peripheral opening of the valve is closed by a face of the cylinder head situated against and facing it, while the wall of the valve closes access both to the suction opening and the discharge opening of the cylinder head, a dose of product then being able to be housed in the recess of the valve, thus closed,
a discharge position, wherein the peripheral opening of the valve communicates with the discharge opening of the cylinder head placed below, while the wall of the valve closes access to the suction opening of the cylinder head and the recess of the valve can empty itself of the dose of product it previously received.

According to one embodiment, it is provided that, relative to the opening position, the other three positions have the following angular values:
suction position: essentially 60□
transitional covering position: essentially 180□
discharge position: essentially 300□.

According to a third aspect, the invention proposes an installation for producing dairy or cheese products (such as from curd and serum) comprising:
intake means for the product to be pumped and dosed with a more or less pasty consistency, placed in an upper portion, including at least one lower outlet opening,
means for distributing the product, including an upper inlet opening and a lower outlet opening, capable of being placed above a mold designed to receive one—or a given number of—dose(s) of the product to be produced, placed in a lower portion, and capable of distributing, via its outlet opening, one—or a given number of—dose(s) of the product into the mold,
a dosing pump as previously described, the axis of which is arranged essentially horizontally, the cylinder head of which is inserted between the intake means and the distribution means, the suction opening of which communicates with the outlet opening of the intake means, and the discharge opening of which communicates with the inlet opening of the distribution means.

According to one embodiment, the installation includes:
a plurality of dosing pumps, arranged to operate in parallel, situated in a same horizontal plane and placed side by side similarly along a same transverse line,
intake means, at least partly shared by the plurality of dosing pumps,
distribution means, including a number of intake openings equal to the number of dosing pumps and a number of outlet openings that is either equal to or less than the number of dosing pumps, at least one of the distribution means having several intake openings for several dosing pumps and an outlet opening corresponding to a mold.

According to one embodiment, the installation includes rotating driving means of the valve at least in part shared by the plurality of dosing pumps.

According to one embodiment, a selective control means of the plurality of dosing pumps is associated with the rotating driving means such that, depending on the needs and configurations, all of the dosing pumps of the plurality of pumps operate simultaneously and in the same way or, on the contrary, only part of the plurality of dosing pumps operate simultaneously, all of the dosing pumps operating according to a cycle determined in advance.

According to one embodiment, the installation includes means forming a screen, situated upstream from the dosing pump(s), capable of retaining any hard bits of the product to be pumped and dosed.

### BRIEF DESCRIPTION OF THE DRAWINGS

We will now describe several embodiments of the invention with the help of the drawings, in which:

FIG. 1 is a cross-sectional diagrammatic view by a vertical axial plane of the dosing pump with its cylinder head, piston and valve, the latter being in the suction position, the intake means of the product to be pumped and dosed and the means capable of moving the discharge opening of the dosing pump and the plurality of molds relatively only being sketched, the molds themselves not being shown; in this figure, the piston is shown in its two extreme end-of-travel positions: a proximal position (solid lines) and a distal position (broken lines).

FIG. 2 is a larger scale perspective view showing the valve from the side of its second free end edge and its adjacent end openings, its peripheral opening being arranged above,

FIG. 3 is a partial view, in cross-section by a vertical transverse plane of FIG. 1, along line AA, showing the cylinder head, the piston and the valve of the dosing pump, the valve being in the suction position,

FIG. 4 is a partial top view showing the shape of the suction opening of the cylinder head,

FIG. 5 is a view similar to FIG. 4, showing four suction openings side by side, illustrating an embodiment with four dosing pumps arranged in parallel,

FIG. 6 is an elevation view, from the side, showing four dosing pumps arranged in parallel,

FIGS. 7A, 7B, 7C and 7D are four cross-sectional views by a vertical transverse plane of FIG. 1, showing the relative position of the valve in relation to the cylinder head and its suction and discharge openings, respectively in open position, suction position, transitional covering position, and lastly in discharge position,

FIGS. 8A and 8B are two diagrammatic top views illustrating two essentially similar installations, in particular having a same number of pumps —16 in this case, designed for two cases differing by the number of molds to be filled per line, 16 molds and 12 molds, respectively, these diagrams thus illustrating the flexibility of the installation.

### DETAILED DESCRIPTION

The installation is described in relation to a product to be pumped and dosed P with a more or less pasty consistency, such as typically for the production of dairy or cheese products, in this case a curd with serum. Such a product P is essentially free from hard bits. If applicable, the installation includes means forming a screen, situated upstream from the dosing pump 1, capable of retaining any such hard bits. Other than that it is pasty and in this case heterogeneous, the product P is fragile. Of course, the invention applies to products to be pumped and dosed P other than curd with serum, and other than dairy or cheese products, but having a similar more or less pasty consistency.

An installation for producing a product P comprises, in a manner known in itself, firstly, intake means 2 of the product P placed in the upper portion, such as a filling hopper. This intake means 2 includes, in the lower portion, at least one outlet opening 3.

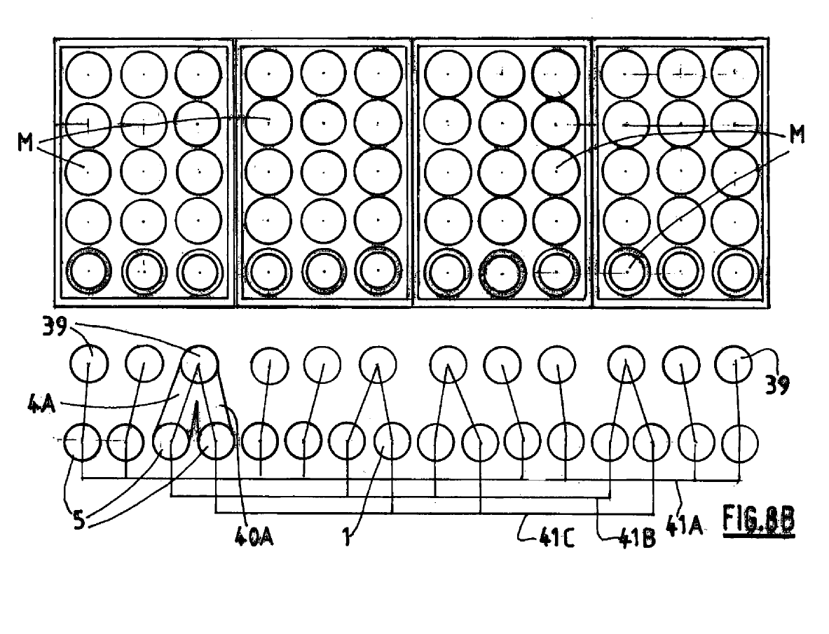

The installation then comprises, also in a manner known in itself, a plurality of molds M (FIGS. 8A and 8B) designed to receive one—or a given number of—dose(s) of the product P. This plurality of molds M is placed in the lower portion. The molds M are typically arranged in lines and columns.

For example, in the case of FIG. 8A, sixteen molds M are provided on a same line, while in the case of FIG. 8B, twelve molds M are provided, the latter having a larger diameter than the former and corresponding to another variety of cheese.

The installation then comprises, also in a manner known in itself, means 4 for distributing the product, including at least one upper inlet opening 5 and at least one lower outlet opening 39. These distribution means 4 can assume the form of conduits 40. These distribution means 4 are placed above the molds. They are capable of distributing, via one—or several—outlet opening(s) 39, one—or a given number of—dose(s) of the product into each of the molds M of the plurality of molds.

In one embodiment (FIG. 8A), there are as many pumps (in this case sixteen) as there are molds M in line. In such a case, a distribution means 4 is provided on a same line (matching the line of molds M), but compartmentalized, segmented or plural, such that each pump 1 has a corresponding mold M and, between the two, a distribution means 4 having a single upper inlet opening 5 and a single lower outlet opening 39, connected by a single conduit 40.

The installation can, in another embodiment (FIG. 8B), with a same number of pumps 1 as before (in this case sixteen), operate for a smaller number of molds M on line (in this case twelve). It is then provided that the distribution means 4 is generally arranged as before, but that certain distribution means 4—in this case 4A—are shared by several pumps 1 and a single mold M. Such a distribution means 4A then includes several upper inlet openings 5, the same number as there are pumps 1, but a single lower outlet opening 39, the openings 5 and 39 being connected by a V- or Y-shaped conduit, diagrammatically illustrated in 40A. It will be shown below how such an installation functions.

The installation also comprises at least one dosing pump 1, the axis 6 of which is arranged essentially horizontally.

The installation can include not just one, but a plurality of dosing pumps 1 arranged to operate in parallel, situated in a same horizontal plane and placed side by side similarly along the length of a same transversal line (relative to the axis 6).

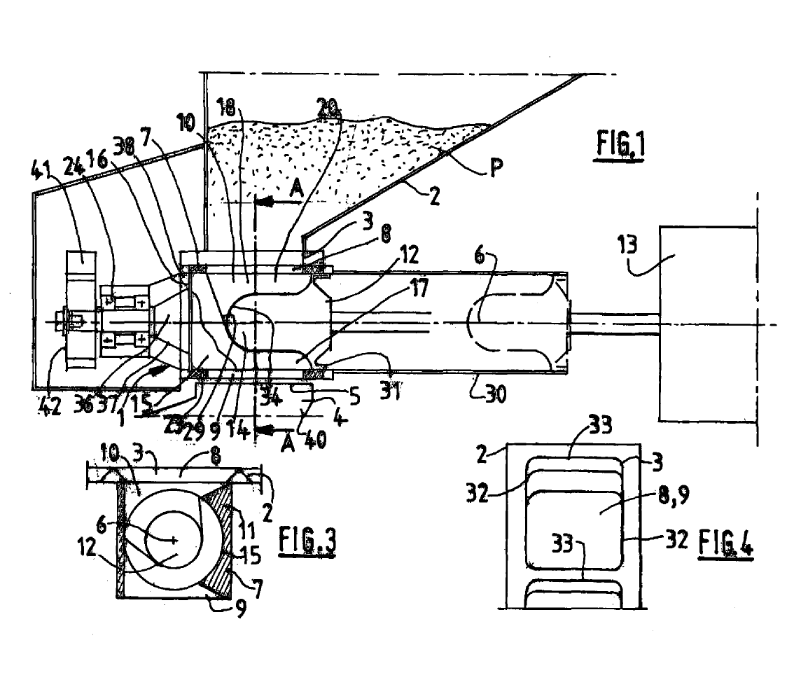

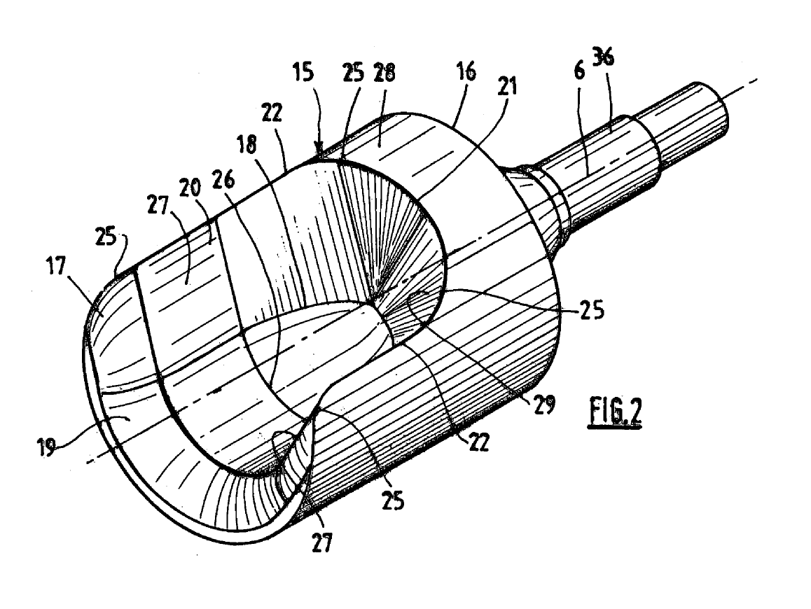

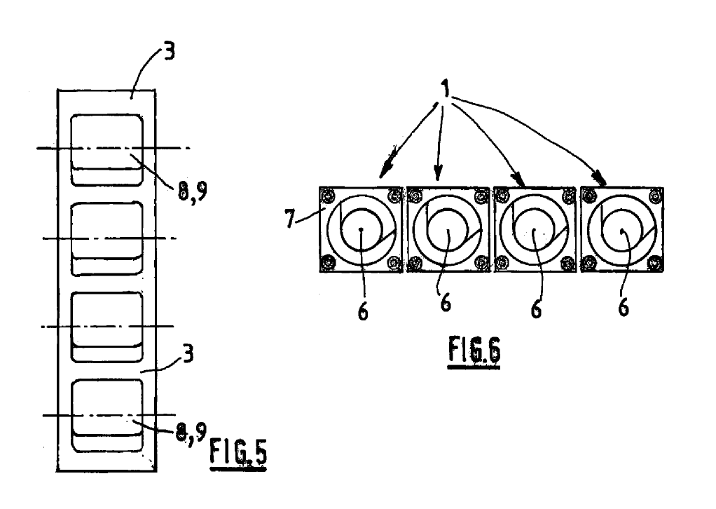

In the embodiment illustrated in FIGS. 4 and 6, four dosing pumps 1 are provided. Of course, the invention is not limited to that number. In the embodiment covered by FIGS. 8A and 8B, sixteen dosing pumps are provided, as previously indicated.

In the case where several dosing pumps 1 are provided, it is also provided that the intake means 2 include the same number of outlet openings 3 as dosing pumps 1.

As previously described, it is provided that the distribution means 4 includes as many intake openings 5 as dosing pumps 1 and a number of outlet openings 39 equal to or less than the number of dosing pumps 1.

The dosing pump 1 includes a cylinder head 7, inserted between the intake means 2 and the distribution means 4.

The cylinder head 7 comprises an upper suction opening 8 capable of communicating with the corresponding outlet opening 3 of the intake means 2.

The cylinder head 7 also comprises a lower discharge opening 9 capable of communicating with the corresponding intake opening 5 of the distribution means 4.

The words “upper”, “lower”, “above”, “below”, “horizontal”, “vertical” . . . refer to the in situ installation needed to operate.

In the illustrated embodiment, the suction opening 8 and the discharge opening 9 are essentially diametrically opposite relative to the axis 6, the second overhanging the first.

The cylinder head 7 of the pump 1 forms a transfer chamber 10, revolving with axis 6. More precisely, the jacket of the transfer chamber 10 has a generally circular cylindrical shape.

The suction 8 and discharge 9 openings, radially staggered relative to each other by 180°, but of the same axial position, are arranged in the wall 11 of the chamber 10.

The pump 1 includes a mobile suction and discharge piston 12. The piston 12 can be moved by sliding along the axis 6, relative to the cylinder head 7, by sliding driving means 13.

The piston 12 can assume two extreme end-of-travel positions: a proximal position and a distal position. In the proximal position, the head 14 of the piston 12 is at least essentially located in the transfer chamber 10. In the distal position, the head 14 is at least essentially outside the transfer chamber 10.

To allow the sliding between these two extreme positions, it is provided that the chamber 10 extends, on the piston 12 side, by a sleeve 30 of generally circular cylindrical shape with axis 6 wherein the head 14 of the piston 12 is found in the distal position.

Of course, one or several O-rings 31 are provided between the outer side face of the piston 12 and the corresponding inner side face of the sleeve 12, if applicable of the chamber 10.

The pump 1 also includes a pivoting dosage and transfer valve.

The valve 15 has a first free end edge 16 and a second free end edge 17, at its two axial ends (relative to the axis 6). The valve 15 fits into an outer revolving jacket complementary to that of the transfer chamber 10. As for the transfer chamber 10, this jacket has a generally circular cylindrical shape, with axis 6.

The valve 15 includes an inner recess 18. This recess 18 also fits into a revolving jacket of circular, generally cylindrical or pseudo cylindrical shape, with axis 6.

The recess 18 has, first, an end opening 19 adjacent to the second free end edge 17. This opening 19 allows the head 14 of the piston 12 to enter, be housed in and leave the recess 18.

The head 14 of the piston 12 is also generally circular cylinder-shaped, at least in part essentially complementary to that of the recess 18 of the valve 15. Moreover, it includes a distal face 34, with a generally hemispheric shape.

The recess 18 then has a peripheral opening 20, situated on its cylindrical wall defining its outer face 28. The peripheral opening 20 has, in elevation, a generally U- or □-shaped (square or rectangular) contour, as will be seen.

The peripheral opening 20 is limited, on one hand, by at least a first transverse edge 21, situated toward the first free end edge 16 of the valve 15, while being separated therefrom. The peripheral opening 20 is limited, on one hand, by two longitudinal edges 22, arranged essentially parallel to each other and to the direction of the axis 6.

The valve 15 is mounted coaxially (with axis 6) in a portion 23 of the transfer chamber 10 forming a seat, adjacent to its transverse end wall 38 opposite the sleeve 30 of the piston 12. This portion 23 is situated opposite and facing the piston 12.

The valve 15 can be moved rotatably relative to the cylinder head 7, around the axis 6, by rotating driving means 24. To this end, the valve 15 is adjusted at the chamber 10, so as to allow the rotation of the valve 15, with gentle friction and with the desired sealing between the valve 15 and the cylinder head 7. Moreover, the valve 15 includes an axial shank or journal 36, situated on the side of the first free end edge 16, capable of passing through a passage 37 formed to that end in the transverse end wall 38 of the chamber 10.

The driving means 24 is for example a gear motor supported by the cylinder head 7.

When several dosing pumps 1 are provided, the means 24 can be partially shared by all of the pumps. For example, a motor means can be provided shared by all of the dosing pumps, means 41 for transmitting movement functionally connected to the motor means (such as racks, belts, threaded shaft or other) to transmit the movement imparted by the latter to pinions 42 or similar, one for each dosing pump 1, wedged on the shanks 36 of the different valves 15 of the different dosing pumps 1.

Of course, the driving means 24 just described are not limiting.

When several dosing pumps 1 are provided, one may provide, in one possible embodiment, means for selectively controlling the plurality of dosing pumps 1, such that, depending on the needs and configurations, all of the dosing pumps 1 of the plurality of pumps operate simultaneously and in the same way or that, on the contrary, only part of the plurality of dosing pumps 1 operate simultaneously and that all of the dosing pumps operate according to a cycle determined in advance. Such control means can comprise programmable machines. If necessary, a series of operating programs is provided and the installation includes means for selecting the desired program.

Such an embodiment makes it possible in particular to make the installation flexible inasmuch as, with a same given number of dosing pumps 1, one can fill, as desired, a same number of molds M, or a smaller number of molds M, although in fine for a given cycle, all of the pumps will have operated.

To illustrate what has just been stated, we therefore refer again to FIGS. 8A and 8B. In both cases, it is provided that the sixteen valves 15 of the dosing pumps 1 are actuated (in rotation) by three transmission means 41A, 41B and 41C (shown here diagrammatically by lines).

The transmission means 41A is connected here to eight dosing pumps 1.

The transmission means 41B is connected to four other dosing pumps 1.

Lastly, the transmission means 41C is connected to four other dosing pumps 1.

The sixteen successive dosing pumps 1 of the line are therefore thus connected to the transmission means 41: 41A, 41A, 41B, 41C, 41A, 41A, 41B, 41C, 41B, 41C, 41A, 41A, 41B, 41C, 41A, 41A.

In the case of FIG. 8A, where sixteen molds M are provided, the three transmission means 41A, 41B and 41C are controlled to operate simultaneously, the sixteen molds M being filled simultaneously.

In the case of FIG. 8B, where twelve molds M are provided for sixteen dosing pumps 1, the three transmission means 41A, 41B and 41C are controlled to operate according to the following sequence: 41A and 41B or 41A and 41C. In this scenario, the two dosing pumps 1 of each of the four pairs of dosing pumps no. 3 and 4, no. 7 and 8, no. 9 and 10 and lastly no. 13 and 14 (the no. being counted from one end of the line of pumps) are coupled to supply a same mold, molds nos. 3, 6, 7 and 10, respectively.

To do this, a distribution means 4A is then provided connected to the four pairs of dosing pumps no. 3 and 4, no. 7 and 8, no. 9 and 10 and no. 13 and 14 having two upper inlet openings 5 and a single lower outlet opening 39.

In all cases, the arrangement is such that the peripheral opening 20 of the valve 15 can be placed opposite—and in communication with—the suction opening 8 or the discharge opening 9.

In the illustrated embodiment, the valve 15 includes a single peripheral opening 20.

In another embodiment, the valve 15 includes two peripheral openings 20 angularly staggered relative to each other.

In the illustrated embodiment, the peripheral opening 20 has a generally U-shaped contour. In this case, the peripheral opening 20 is limited, on one hand, by a first single transverse edge 21 and, on the other hand, by the two longitudinal edges 22, situated on the outer face 28 of the valve 15. Moreover, the peripheral opening 20 is then separated from the first free end edge 16 of the valve 15 but adjacent to its second free end edge 17. The result is that the peripheral opening 20 and the end opening 19 together form a notch formed in the valve 15.

In another embodiment, not illustrated, the peripheral opening 20 has a generally □-shaped contour. In this case, the peripheral opening 20 is limited, on one hand, by the first transverse edge 21 and a second transverse edge. These transverse edges are separated, respectively, from the first free end edge 16 and from the second free end edge 17 of the valve 15. The peripheral opening 20 is limited, on the other hand, by the two longitudinal edges. Moreover, the peripheral opening 20 is separated both from the first free end edge 16 and the second free end edge 17. It then results that the peripheral opening 20 and the end opening 19 are separate from each other.

In the illustrated embodiment, a longitudinal edge 22 has at least a substantial portion that is essentially rectilinear, while a transverse edge 21 has at least a substantial portion that is essentially in the shape of a circular arc, and therefore rectilinear in elevation (plane of FIG. 2). Furthermore, a rounded portion 25 is provided between a longitudinal edge 22 and either a transverse edge 21 or the second free end edge 17 of the valve 15, when the peripheral opening 20 is adjacent thereto, as described.

Like the peripheral opening 20 of the valve 15, the suction opening 8 and the discharge opening 9 of the cylinder head 7 have a generally □-shaped (square or rectangular) elevation. These openings 8, 9 are limited by two transverse edges 32, essentially rectilinear, and two longitudinal edges 33, also essentially rectilinear and parallel to each other, of axial direction.

Moreover, a suction opening and a discharge opening 8, 9 have, in elevation, a general □ shape, at least equal and possibly even larger and thus envelope the peripheral opening 20 of the valve 15.

In the illustrated embodiment, the peripheral opening 20 extends axially over a substantial portion of the axial length of the valve 15 between its two free end edges 16, 17.

On the other hand, the peripheral opening 20 extends angularly, relative to the axis 6, over an angle α that can go up to the vicinity of 120°.

The possibility results of having a peripheral opening 20 with a large surface, which contributes to a suction and discharge of the product P that are both effective and efficient, and high-performance washing of the pump. This embodiment is particularly well suited to a product to be pumped and dosed P that is pasty, heterogeneous and fragile, as in the case in point.

We will now more particularly describe the recess 18 of the valve 15.

The recess 18 has, in transverse straight section, relative to the axis 6, a general pseudo V shape, the tip, which forms the axial longitudinal bottom 26 of the recess 18, being greatly rounded. The opening angle β of the pseudo V can reach up to the vicinity of 90°. Thus, the recess 18 has a greatly rounded axial longitudinal bottom 26, diametrically opposite the peripheral opening 20.

On either side of the bottom 26, the recess 18 has two side faces 27. These side faces 27 are divergent. They are essentially planar. They extend to the longitudinal edges 22 on the cylindrical outer face 28 of the valve 15. As a result, the thickness of the wall of the valve 15 decreases between the bottom 26 of the recess 18 and the longitudinal edges 22 of the peripheral opening 20.

Moreover, the recess 18 has a face 29,—across from the distal face 34 of the piston 12 head 14 and axially opposite the end opening 19—that is slanted. This slant goes in the direction from the first free end edge 16 to the second free end edge 17 and from the side of the peripheral opening 20 to the rounded axial longitudinal bottom 26 of the recess 18.

In its proximal position, the piston head 14 occupies the largest portion of the recess 18, the faces 29 (of the valve 15) and 34 (of the piston 12) being close, apart from being complementary. A minimal “dead” volume results in the recess 18, which contributes to the qualitative performance of the installation.

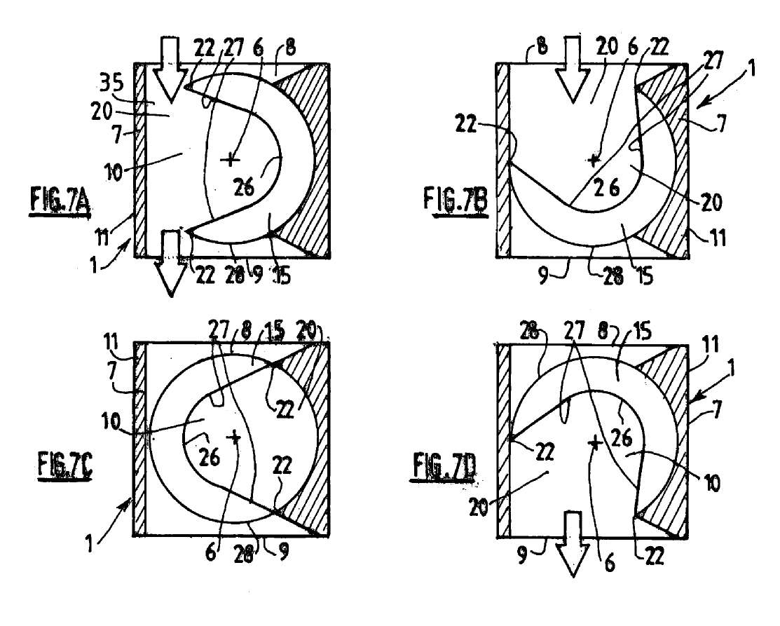

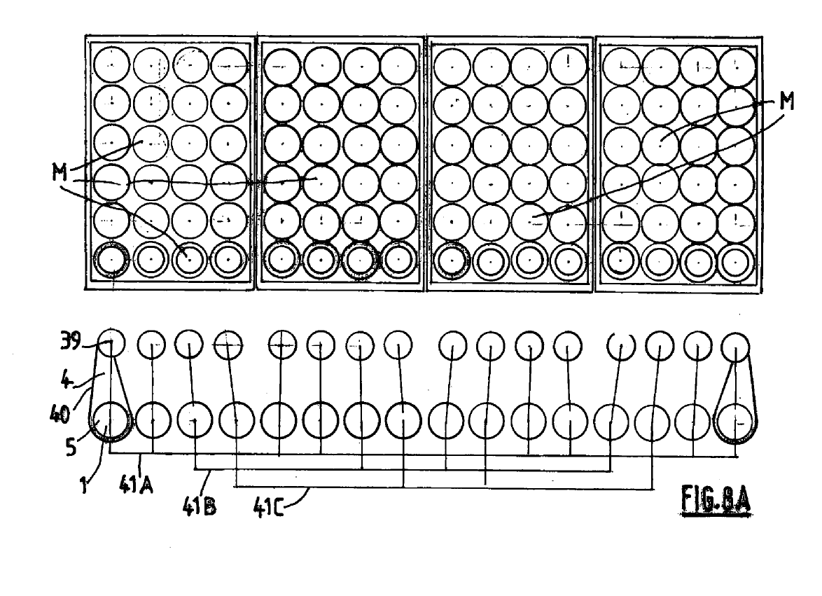

The valve 15 can occupy one of the four functional angular positions described now, i.e. an opening position (FIG. 7A), a suction position (FIG. 7B), a transitional covering position (FIG. 7C) and a discharge position (FIG. 7D).

The opening position is used in particular for washing. In this position, the peripheral opening 20 of the valve 15 is separated from the face of the cylinder head 7 situated facing it. A passage 35 is possible between the suction opening 8 and the discharge opening 9 of the cylinder head 7, via the recess 18 of the valve 15.

The installation includes washing means that can be implemented in this opening position.

The suction position serves, as its name indicates, for suction of the product P found in the intake means 2, through the recess 18, via the suction opening 8. In this position, the peripheral opening 20 of the valve 15 communicates with the suction opening 8 of the cylinder valve 7 placed above. The wall of the valve 15 closes access to the discharge opening 9 of the cylinder head 7. The recess 18 of the valve can receive a dose of product P to be pumped and dosed.

In the transitional covering position, the peripheral opening 20 of the valve 15 is closed by a face of the cylinder head 7 situated against and facing, while the wall of the valve 15 closes access both to the suction opening 8 and to the discharge opening 9 of the cylinder head 7. A dose of product P can then be housed in the recess 18 of the valve 15, thus closed.

The discharge position serves, as its name indicates, to discharge the product P found in the recess 18, toward the distribution means 4, via the discharge opening 9. In this position, the peripheral opening 20 of the valve 15 communicates with the discharge opening 9 of the cylinder head 7 placed below. The wall of the valve closes access to the suction opening 8 of the cylinder head 7. The recess 18 of the valve can empty itself of the dose of product P it has previously received.

In the considered embodiment, relative to the open position, the other three positions have the following angular values:
suction position: essentially 60□
transitional covering position: essentially 180□
discharge position: essentially 300□.

Of course, the pump and the installation include control means, such as one or several programmable machines, such that the operation is done according to repetitive cycles.

The pump and the installation also include control and security means, capable of making it possible to ensure correct operation or note a malfunction.

The pump and the installation can also include means for measuring the doses of product P distributed.88

1. A dosing pump, specially designed for a product to be pumped and dosed with a more or less pasty, especially heterogeneous and fragile, consistency, comprising, along a axis:
a cylinder head having a transfer chamber, a suction opening and a discharge opening in same axial position, radially staggered in relation to each other,
a revolving dosage and transfer valve, that can be rotatably displaced in relation to the cylinder head, between functional angular positions, including a recess having an end opening adjacent to free end edge and a peripheral opening that can communicate with the suction opening in suction position and with the discharge opening in discharge position,
a mobile suction and discharge piston that can be axially slid in relation to the cylinder head, by driving means, between a proximal position, wherein head is in the chamber and the recess and a distal position wherein head is out of the chamber and housed into a sleeve that prolongs the chamber, the head being housed or not into the recess having an at least partially complementary shape
a circular cylindrical chamber,
a circular cylindrical valve, being complementary of and adjusted to the chamber in order to allow for an tight rotation, and installed in a part of the chamber forming a seat adjoining end transversal wall,
faces of the valve and of the piston that, in a proximal position of the piston are close and complementary, with only a minimal dead space volume,
a peripheral opening having a U-shaped, square, rectangular contour, limited by a first transverse edge situated toward the free end edge of the valve while being separated therefrom and two longitudinal edges arranged parallel to each other and to the direction of the axis.

2. The pump according to claim 1,
a single peripheral opening.

3. The pump according to claim 1,
two peripheral openings angularly staggered in relation to each other.

4. The pump according to 1, in the case of a peripheral opening having a generally U-shaped contour, the peripheral opening, firstly, is limited, on one hand, by a first single transverse edge and, on the other hand, by two longitudinal edges, and, secondly, is separated from the first free end edge of the valve and adjacent to second free end edge, the peripheral opening and the end opening together forming a notch formed in the valve.

5. The pump according to 1, in the case of a peripheral opening having a generally shaped contour, the peripheral opening, firstly, is limited, on one hand, by a first and a second transverse edge respectively separated from the first and second free end edges of the valve, and, on the other hand, by two longitudinal edges, and, secondly, is separated from the first and second free end edges of the valve.

6. The pump according to 1, at least a substantial portion
is essentially rectilinear.

7. The pump according to 1, at least a substantial portion
is essentially circular arc-shaped, rectilinear in elevation.

8. The pump according to 1, a rounded portion between a longitudinal edge and either a transverse edge or the second free end edge of the valve when the peripheral opening is adjacent thereto.

9. The pump according to 1, a peripheral opening extending axially over a substantial portion of the axial length of the valve between its two free end edges (16, 17).

10. The pump according to 1, peripheral opening angularly, relative to the axis of the valve, over an angle α that can reach the vicinity of 120°.

11. The pump according to 1, recess into a revolving jacket of circular, cylindrical or pseudo cylindrical shape.

12. The pump according to 1, recess, in transverse straight section, relative to the axis of the valve, a general pseudo V shape, tip, forming the axial longitudinal bottom of the recess, being greatly rounded.

13. The pump according to claim 12, an opening angle β of the pseudo V reach the vicinity of 90°.

14. The pump according to 12, recess a rounded axial longitudinal bottom diametrically opposite the peripheral opening and, on either side of bottom, two diverging side faces, essentially planar, extend up to the longitudinal edges on the cylindrical outer face of the valve, thickness of which decreases between the bottom of the recess and the longitudinal edges of the peripheral opening.

15. The pump according to 1, recess a face axially opposite the end opening slanted in direction going from the first to the second free end edge and from side of the peripheral opening to rounded axial longitudinal bottom of the recess.

16. The pump according to 1, suction opening and discharge opening
a generally shaped elevation limited by two transverse edges and two longitudinal edges essentially parallel and of axial direction.

17. The pump according to 1, suction opening and discharge opening, in elevation, a general shape at least equal and possibly larger and to envelope the peripheral opening of the valve.

18. The pump according to 1, a piston head of generally cylindrical shape and a distal face of generally hemispheric shape.

19. The pump according to 1, the valve is arranged with regard of the cylinder head so as to be able to adopt an opening position, in particular for washing, in which the peripheral opening of the valve is separated from the face of the cylinder head situated facing it, a passage being possible between the suction opening and the discharge opening of the cylinder head, via the recess of the valve,

20. The pump according to 1, suction opening and discharge opening essentially diametrically opposite in relation to the axis of the chamber and of the valve.

21. The pump according to claim 20, the valve one of the following four functional angular positions:
an opening position, in particular for washing, in which the peripheral opening of the valve is separated from the face of the cylinder head situated facing, a passage being possible between the suction opening and the discharge opening of the cylinder head, via the recess of the valve,
a suction position, wherein the peripheral opening of the valve communicates with the suction opening of the cylinder head placed above, while wall of the valve closes the access to the discharge opening of the cylinder head and the recess of the valve can receive a dose of product to be pumped and dosed,
a transitional covering position, wherein the peripheral opening of the valve is closed by a face of the cylinder head situated against and facing,
while the wall of the valve closes access both to the suction opening and the discharge opening of the cylinder head, a dose of product then being able to be housed in the recess of the valve, thus closed,
a discharge position, wherein the peripheral opening of the valve communicates with the discharge opening of the cylinder head placed below, while the wall of the valve closes access to the suction opening of the cylinder head and the recess of the valve can empty itself of the dose of product it previously received.

22. The pump according to claim 21, in relation to the opening position, the other three positions have the following angular values:
suction position: essentially 60□
transitional covering position: essentially 180□
discharge position: essentially 300□.

23. An installation for producing dairy or cheese products, comprising:
intake means for the product to be pumped and dosed with a more or less pasty consistency, placed in an upper portion, including at least one lower outlet opening,
means for distributing the product, including an upper inlet opening and a lower outlet opening, capable of being placed above a mold designed to receive one—or a given number of—dose(s) of the product to be produced, placed in a lower portion, and capable of distributing, via outlet opening, one—or a given number of—dose(s) of the product into the mold,
a dosing pump according to 1, the axis of which is arranged essentially horizontally, the cylinder head of which is inserted between the intake means and the distribution means, the suction opening of which communicates with the outlet opening of the intake means, and the discharge opening of which communicates with the inlet opening of the distribution means.

24. The installation according to claim 23:
a plurality of dosing pumps, arranged to operate in parallel, situated in a same horizontal plane and placed side by side similarly along a same transverse line,
intake means, at least partly shared by the plurality of dosing pumps,
distribution means, including a number of intake openings equal to the number of dosing pumps and a number of outlet openings that is either equal to or less than the number of dosing pumps, at least one of the distribution means having several intake openings for several dosing pumps and an outlet opening corresponding to a mold.

25. The installation according to claim 24, rotational driving means at least partially shared by the plurality of dosing pumps.

26. The installation according to 24, the rotational driving means are connected with means for selectively controlling the plurality of dosing pumps, such that, depending on the needs and configurations, all of the dosing pumps of the plurality of pumps operate simultaneously and in the same manner or, on the contrary, only part of the plurality of dosing pumps operate simultaneously, all of the dosing pumps operating according to a cycle determined in advance.

27. The installation according to 25, means forming a screen, situated upstream from the dosing pump(s), capable of retaining any hard bits of the product to be pumped and dosed.
